(19) United States
(12) Patent Application Publication
(10) Pub. No.: US 2016/0379117 A1
(43) Pub. Date: Dec. 29, 2016

(54) LOCATION-BASED DELIVERY OF STRUCTURED CONTENT

(71) Applicant: Google Inc., Mountain View, CA (US)

(72) Inventors: Alexander Faaborg, Mountain View, CA (US); Aparna Chennapragada, Mountain View, CA (US)

(21) Appl. No.: 14/754,609

(22) Filed: Jun. 29, 2015

(51) Int. Cl. G06N 5/02; G06N 5/04

(52) U.S. Cl. CPC G06N 5/02; G06N 5/048

(57) ABSTRACT

In one example, a computing system includes at least one processor, a communication unit, and a predictive knowledge system. The predictive knowledge system is operable by the at least one processor to determine, based at least in part on the current location of the computing device, a particular geographic region from a plurality of defined geographic regions, the particular geographic region including the current location of the computing device, determine, based on an aggregated web access history for a plurality of computing devices, a content source associated with the particular geographic region, receive, from the content source, content designated for use by the predictive knowledge system, and send, via the communication unit and to the computing device, at least a portion of the content.

### BACKGROUND

Content providers may provide content, such as webpages, text messages, advertisements, notifications, or other content, to various devices via one or more networks. For instance, a user of a computing device may cause a computing device to send a request for content to a content provider and, in response, the computing device may receive the requested content. Rather than providing content in response to an explicit user request, predictive knowledge systems may push content to devices in a predictive manner. Predictive knowledge systems may generate the content pushed to the devices based on information from third-parties while preventing third parties from directly pushing content to the devices using the predictive knowledge system so as to prevent undesirable content from being pushed to the devices.

### SUMMARY

In one example a method includes receiving, by a predictive knowledge system executing on a computing system, an indication of a current location of a computing device, determining, by the predictive knowledge system, based at least in part on the current location of the computing device, a particular geographic region from a plurality of defined geographic regions, the particular geographic region including the current location of the computing device, and determining, by the predictive knowledge system, based on an aggregated web access history for a plurality of computing devices, a content source associated with the particular geographic region. The method may also include receiving, by the predictive knowledge system, from the content source, content designated for use by the predictive knowledge system, and sending, by the predictive knowledge system, to the computing device, at least a portion of the content designated for use by the predictive knowledge system.

In another example a computing system includes at least one processor, a communication unit, and a predictive knowledge system. The predictive knowledge system is operable by the at least one processor to determine, based at least in part on the current location of the computing device, a particular geographic region from a plurality of defined geographic regions, the particular geographic region including the current location of the computing device, determine, based on an aggregated web access history for a plurality of computing devices, a content source associated with the particular geographic region, receive, from the content source, content designated for use by the predictive knowledge system, and send, via the communication unit and to the computing device, at least a portion of the content.

In another example a computer-readable storage medium is encoded with instructions that, when executed, cause one or more processors of a computing system to receive an indication of a current location of a computing device, determine, based at least in part on the current location of the computing device, a particular geographic region from a plurality of defined geographic regions, the particular geographic region including the current location of the computing device, and determine, based on an aggregated web access history for a plurality of computing devices, a content source associated with the particular geographic region. The instructions may further cause the one or more processors to receive, from the content source, content designated for use by a predictive knowledge system, and send, to the computing device, at least a portion of the content.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computing environment that includes a computing system configured to provide contextual delivery of relevant third party content, in accordance with one or more techniques of the present disclosure.

FIG. 2 is a block diagram illustrating an example computing system configured to provide contextual delivery of relevant third party content, in accordance with one or more techniques of the present disclosure.

FIG. 3 is a block diagram illustrating example content received from a content source, in accordance with one or more techniques of the present disclosure.

FIG. 4 is a flow diagram illustrating example operations of a computing system configured to provide contextual delivery of relevant third party content, in accordance with one or more techniques of the present disclosure

FIG. 5 is a flow diagram illustrating example operations of a computing system configured to provide contextual delivery of relevant third party content, in accordance with one or more techniques of the present disclosure.

### DETAILED DESCRIPTION

In general, techniques of the present disclosure may enable a predictive knowledge system to provide access to third parties while reducing the likelihood of undesirable content being pushed to devices. For instance, a computing system configured in accordance with the techniques described herein may execute a predictive knowledge system that may proactively provide, to mobile devices, content having a structure populated by third parties. That is, the predictive knowledge system may provide content types and structures for the content types to third parties for the third parties to populate with content. By including the content in the structures, the predictive knowledge system determines that the content is designated for use by the predictive knowledge system.

The predictive knowledge system may provide the third party content to users in a predictive fashion. For instance, based on a current context of a computing device, the predictive knowledge system may determine a content provider that is likely to be relevant to a user of the computing device. The predictive knowledge system may obtain content, from the content provider, that is designated for use by the predictive knowledge system and send the content to the computing device for output in accordance with the structure defined by the predictive knowledge system. In other words, a computing system may implement the techniques of this disclosure to create a scalable architecture that various third parties can leverage to proactively provide content to users at a time when the users are likely to desire the content.

By creating a scalable architecture usable to predictively provide third party content, the techniques described herein may significantly increase the amount of content available to users, which may thereby improve the relevancy of predictively provided content. Additionally, by enabling third parties to populate structures provided by the predictive knowledge system with the third parties' own content, the techniques of the present disclosure may avoid the increased effort and/or computing resources that may be necessary for a predictive knowledge system to create such content. Furthermore, by determining which content providers may be relevant to the current context of a computing device and only provide content from such content providers, a predictive knowledge system configured in accordance with the techniques described herein may allow third parties to create and provide predictive content while preventing the third parties from abusing or manipulating the system. That is, while the third parties are able to create and provide content, the predictive knowledge system maintains control over when various content will be predictively provided. Thus, the techniques described herein may increase user satisfaction, as provided content is more likely to be truly relevant to each user's current situation.

In general, a computing device of a user may send information about the user or the computing device to the computing system only if the computing device receives permission from the user to send the information. For example, in situations discussed below in which the computing device may collect, transmit, or may make use of personal information about a user (e.g., a current location, content sources accessed, emails, text messages, etc.) the user may be provided with an opportunity to control whether programs or features of the computing device can collect such user information, or to control whether and/or how the computing device may store and share such user information.

In addition, certain data may be treated in one or more ways before it is stored, transmitted, or used by the computing device so that personally identifiable information is removed. For example, a user's identity may be treated so that no personally identifiable information can be determined about the user, or a user's geographic location may be generalized when location information is obtained (such as to a city block, ZIP code, or city level), so that a particular location of the user cannot be determined. Thus, the user may have control over how information is collected about the user and stored, transmitted, and/or used by the computing device.

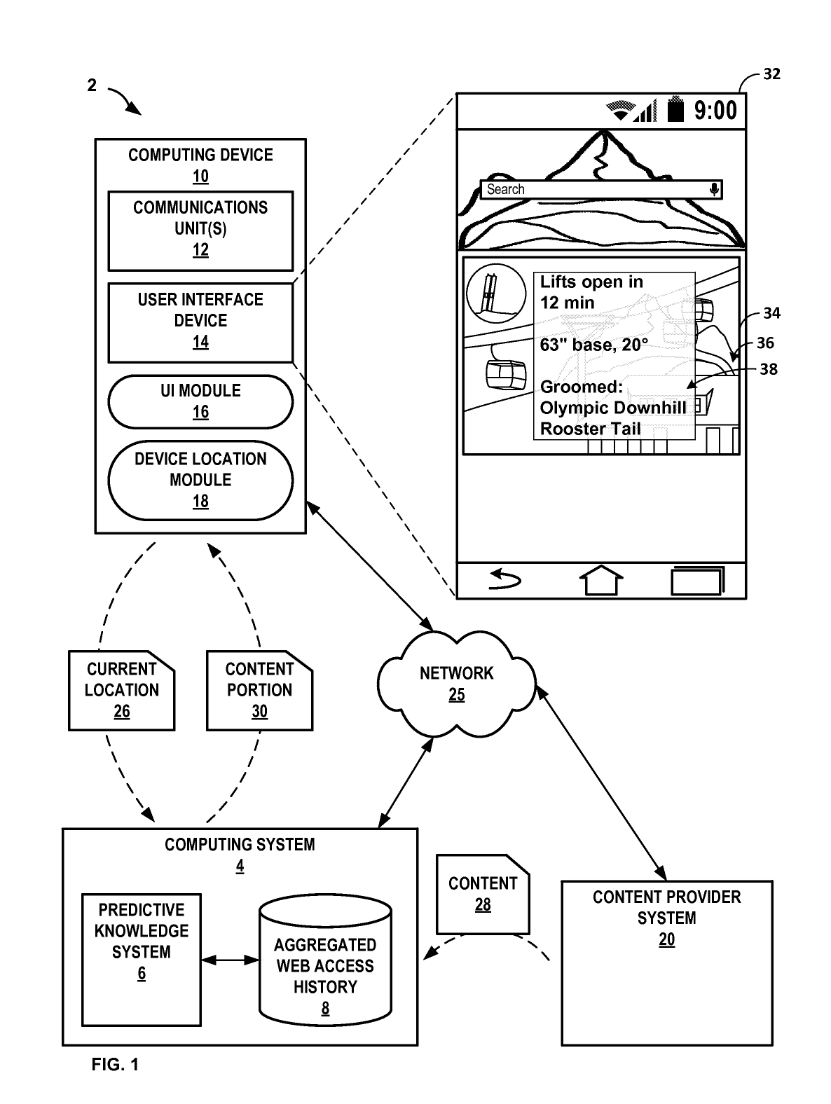

FIG. 1 is a block diagram illustrating an example computing environment 2 that includes a computing system 4 configured to provide contextual delivery of relevant third party content, in accordance with one or more techniques of the present disclosure. As shown in the example of FIG. 1, computing environment 2 also includes computing device 10 and content provider system 20. Examples of computing system 4, computing device 10, and/or content provider system 10 include server devices, desktop computers, laptop computers, smart television platforms, in-vehicle entertainment systems, mobile computing devices such as a mobile telephone (e.g., a smart phone) or a personal digital assistant (PDA), wearable computing devices such as a smart watch or head mounted computing device, or other computing devices. In some examples, computing system 4 and/or content provider system 10 may be a collection of computing devices, capable of communicating via a network to share computing resources and collaboratively accomplish tasks. That is, computing system 4 and/or content provider system 10 may, in some examples, be “cloud” computing systems.

In the example of FIG. 1, computing system 4, computing device 10, and content provider system 20 are connected via network 25. Network 25 may represent any communication network, such as a packet-based digital network. In some examples, network 25 may represent any wired or wireless network such as the Internet, a private corporate intranet, or a public switched telephone network (PSTN). Network 25 may include both wired and wireless networks as well as both public and private networks.

As shown in the example of FIG. 1, computing device 10 includes one or more communication units 12, user interface (UI) device 14, UI module 16, and device location module 18. Communication units 12 may include a network interface card, such as an Ethernet card, an optical transceiver, a radio frequency transceiver, or any other type of device that can send and receive information. Other examples of communications units 12 may include Bluetooth, 3G and WiFi radio components as well as Universal Serial Bus (USB) adaptors. In some examples, computing device 10 may utilize communication units 12 to communicate, via network 25, with computing system 4, content provider system 20, or other computing devices. For instance, one or more components of computing device 10 may send data to communication units 12 for transmission to computing system 4 via network 25.

UI device 14 of computing device 10 may function as an input device and/or an output device for computing device 10. UI device 14 may be implemented using various technologies. For instance, UI device 14 may function as an input device using a presence-sensitive input screen, such as a resistive touchscreen, a surface acoustic wave touchscreen, a capacitive touchscreen, a projective capacitance touchscreen, a pressure sensitive screen, an acoustic pulse recognition touchscreen, or another presence-sensitive screen technology. UI device 14 of computing device 10 may include a presence-sensitive screen that may receive tactile input from a user of computing device 10. UI device 14 may receive indications of the tactile input by detecting one or more gestures from the user (e.g., when the user touches or points to one or more locations of UI device 14 with a finger or a stylus pen).

UI device 14 may function as an output (e.g., display) device using any of one or more display devices, such as a liquid crystal display (LCD), dot matrix display, light emitting diode (LED) display, organic light-emitting diode (OLED) display, e-ink, or similar monochrome or color display capable of outputting visible information to a user of computing device 10. For instance, UI device 14 may present output to a user of computing device 10 at a presence-sensitive screen. UI device 14 may present the output as a graphical user interface which may be associated with functionality provided by computing device 10. For example, UI device 14 may present various user interfaces of application modules (not shown) executing at or accessible by computing device 10 (e.g., a predictive knowledge application, an electronic message application, an Internet browser application, etc.). A user of computing device 10 may interact with a respective user interface of an application module to cause computing device 10 to perform operations relating to a function.

UI module 16 and device location module 18 of computing device 10 may perform operations described using hardware, software, firmware, or a mixture of hardware, software, and firmware residing in and/or executing at computing device 10. Computing device 10 may execute modules 16 and 18 with one processor or with multiple processors. In some examples, computing device 10 may execute modules 16 and 18 as a virtual machine executing on underlying hardware. Modules 16 and 18 may execute as a service of an operating system or computing platform or may execute as one or more executable programs at an application layer of a computing platform.

UI module 16 may be operable (e.g., by one or more processors of computing device 10) to receive input from UI device 14. For instance, UI module 16 may receive one or more indications of user input performed at UI device 14. Responsive to receiving an indication of user input, UI module 16 may provide data, based on the received indication, to one or more other components of computing device 10 (e.g., application modules, module 18, etc.). UI module 16 may be operable to provide UI device 14 with output for display. For instance, UI module 16 may receive data for display from one or more other components of computing device 10 (e.g., application modules, module 18, etc.). Responsive to receiving data for display, UI module 16 may cause UI device 14 to display one or more graphical user interfaces. That is, UI module 16 may, in some examples, enable one or more components of computing device 10 to communicate with UI device 14, receive user input performed at UI device 14, and/or provide output to a user at UI device 14.

Device location module 18 may be operable (e.g., by one or more processors of computing device 10) to determine a current location of computing device 10. For example, computing device 10 may include a global positioning system (GPS) radio (not shown) for receiving GPS signals (e.g., from a GPS satellite). Device location module 10 may analyze the GPS signals received by the GPS radio and determine the current location of computing device 10. Computing device 10 may include other radios or sensor devices (e.g., cellular radio, Wi-Fi radio, etc.) capable of receiving signal data from which device location module 18 can determine the current location of computing device 10. In some examples, device location module 18 may determine location information as coordinate (e.g., GPS) location information. In other examples, device location module 18 may determine location information as one or more general or relative locations, such as an address, a place, a country, a city, a type of building (e.g., a library, an airport, etc.).

One or more components of computing device 10 may determine a current location of computing device 10 only if computing device 10 receives permission from the user to determine the information. Additionally, computing device 10 may use and/or transmit location information only if computing device 10 receives permission from the user to share location information (e.g., with an external service, with one or more contacts, etc.). That is, in any situation in which computing device 10 may collect, data mine, analyze and/or otherwise make use of personal information about the user, the user may be provided with an opportunity to control whether programs or features of computing device 10 can collect user information (e.g., previous communications, information about a user's e-mail, a user's social network, social actions or activities, a user's preferences, a user's current location, or a user's past locations). The user may also be provided with an opportunity to control whether and how computing device 10 may transmit such user information. In addition, certain data may be treated in one or more ways before it is stored, transmitted, or used by computing device 10 or other services, so that personally identifiable information is removed. Thus, the user of computing device 10 may have control over how information is collected about the user and used by computing device 10 and other services.

In some examples, device location module 18 may determine current locations of computing device 10 periodically, such as every 15 minutes, every hour, or at some other frequency. In some examples, device location module 18 may determine current locations of computing device 10 responsive to receiving input from a user of computing device 10, such as input instructing computing device 10 to determine the current location, input instructing computing device 10 to access content (e.g., a webpage), or other input. In some examples, device location module 18 may determine current locations based on other criteria, such as movement of computing device 10 as detected by one or more accelerometers (not shown) of computing device 10.

In some examples, device location module 18 or other components of computing device 10 may store data indicating one or more determined current locations of computing device 10 and associated times at which the current locations were determined (e.g., a location history), such as in a database. Additionally or alternatively, device location module 18 may output data indicating the determined current location to one or more other components of computing device 10. In the example of FIG. 1, for instance, device location module 18 may determine a current location within a small Colorado town that is given the fictional name of “Skiville” for purposes of this application. Device location module 18 may output data indicating the determined current location to communications units 12. As a result, communications units 12 may transmit current location 26 to computing system 4 (e.g., via network 25).

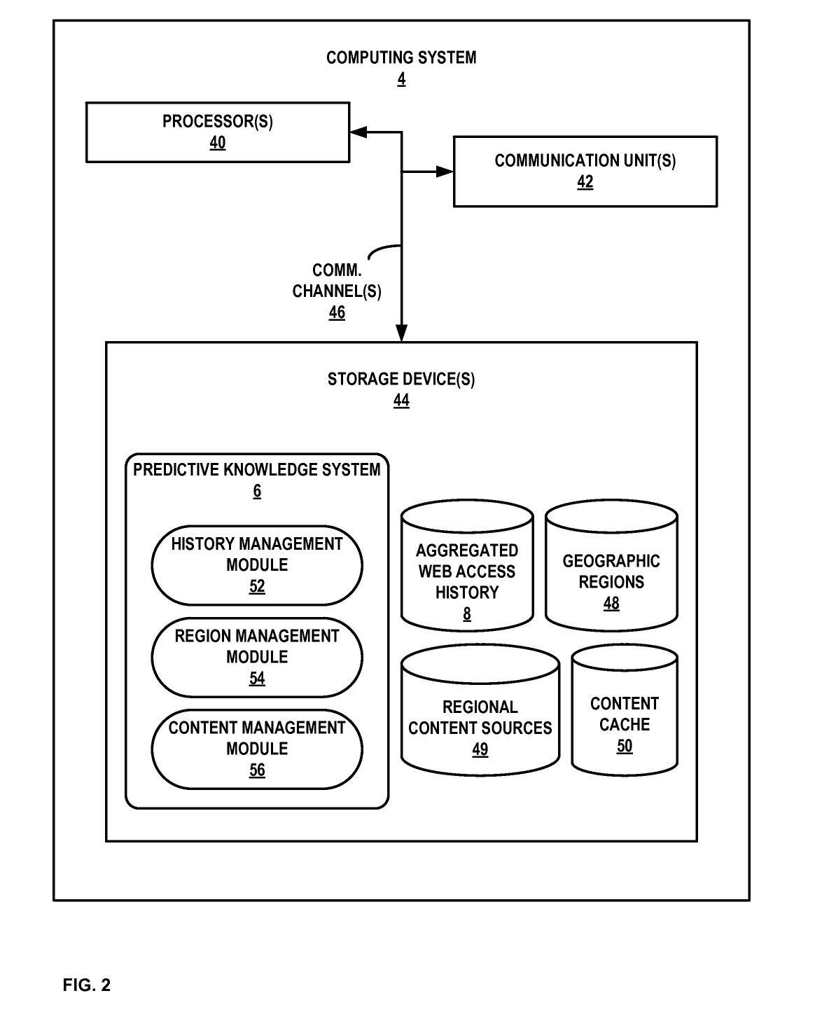

In the example of FIG. 1, computing system 4 includes predictive knowledge system 6 and aggregated web access history 8. In various examples, computing system 4 may also include one or more other components, as further described below with respect to FIG. 2. Predictive knowledge system 6, in the example of FIG. 1, may represent a collection of hardware and software and/or firmware operable to determine and/or generate information that is contextually relevant to one or more computing devices. That is, predictive knowledge system 6 may receive information from computing devices (e.g., information about the computing device, information about the physical environment in which the computing device is located, information about a user of the computing device, information from a user account associated with a user of the computing device, or any other information) and determine contexts of the computing devices based on the received information. Predictive knowledge system 6 may use the determined context to determine and/or generate information determined to likely be relevant to a user of the computing device. Predictive knowledge system 6 may then send the likely relevant information to the computing device (e.g., for display to a user of the computing device). In this way, predictive knowledge system 6 may allow computing devices to “intelligently” provide users with information that is likely to be helpful in a timely, proactive fashion. That is, users may not need to search for or otherwise indicate a desire for such information. The information may be provided in a proactive manner.

Aggregated web access history 8, in the example of FIG. 1, may be a collection of data (e.g., a database or other data structure(s)) that can be used to determine what content sources were accessed by users, and from where the content sources were accessed. For instance, aggregated web access history 8 may, in some examples, be a set of content sources (e.g., Uniform Resource Locators (URLs)) and respective locations (e.g., latitude and longitude coordinates). Aggregated web access history 8 may, in some examples, include additional information about the content source accesses, such as a time at which the content source was accessed, an amount of data transferred to and/or from the content source, a type of device that accessed the content source, or other information.

In the example of FIG. 1, predictive knowledge system 6 may receive an indication of a current location of computing device 10. For instance, computing system 4 may include one or more communications units. The communications units of computing system 4 may be operable to communicate via network 25 and may receive, from computing device 10, current location 26. Current location 26 includes information (e.g., latitude and longitude values) identifying the current location of computing device 10 (e.g., a location within Skiville, Colo.). In some examples, current location 26 may also include information identifying computing device 10, such as a unique device identifier, and/or information about computing device 10, such as a device type, an indication of one or more application modules installed at computing device 10, indications of one or more settings values (e.g., language, region, etc.) of computing device 10, or other information. Computing system 4 may provide an indication of the current location contained in current location 26 to predictive knowledge system 6.

Predictive knowledge system 6, in the example of FIG. 1, may determine, based at least in part on the current location of computing device 10, a particular geographic region from a plurality of defined geographic regions, the particular geographic region including the current location of the computing device. Geographic regions, as used herein, may represent any collection of physical locations. In some examples, the plurality of defined geographic regions may be predefined. For instance, one or more geographic regions may be predefined using other methods of location definition, such as political boundaries (e.g., countries, states, provinces, prefectures, counties, cities, towns, municipalities, census blocks, etc.), geography boundaries (e.g., continents, oceans, mountain ranges, etc.), or other methods of location definition. In some examples, one or more geographic regions may be defined (e.g., by predictive knowledge system 6) using aggregated web access history 8. In some examples, one or more of the defined geographic regions may be static. For instance, a geographic region defining the state of Minnesota may always be the same. In some examples one or more of the defined geographic regions may be more dynamic. For instance, a region that corresponds to a large music festival may exist for the duration of the festival, and increase and/or decrease as the festival becomes more populous. In other words, a geographic region, in general, may be any static or dynamic definition of a physical area.

Predictive knowledge system 6 may compare the current location of computing device 10 to one or more of the plurality of defined geographic regions to determine which geographic region includes the current location of computing device 10. For instance, each geographic region may be bounded by one or more functions of latitude and longitude. If a latitude and longitude corresponding to the current location of computing device 10 is within the bounds of a geographic region, the current location may be determined to be included in the geographic region. Thus, in the example of FIG. 1, predictive knowledge system 6 may determine that the current location of computing device 10 is within a particular geographic region that includes Skiville, Colo.

In the example of FIG. 1, predictive knowledge system 6 may determine, based on aggregated web access history 8, a content source associated with the particular geographic region. A content source, generally, may be any source of content. Examples of content may include webpages, websites, text documents, news articles, weather information, information about a location (e.g., a restaurant's hours of operation, etc.), or other information. In other words, content may represent information and a content source may be a location or entity from which content can be obtained.

As one example of determining a content source associated with the particular geographic region, predictive knowledge system 6 may access aggregated web access history 8 and retrieve information indicating some or all of the content sources that were accessed from the particular geographic region that includes Skiville, Colo. Predictive knowledge system 6 may use the retrieved information to determine one or more content sources that are associated with the geographic region. For instance, predictive knowledge system 6 may determine a content source that is accessed the most number of times by users within the particular geographic region. Other examples of content sources associated with a geographic region may include the content source most recently accessed from the geographic region, the content source accessed most often within a duration of time ranging from the current time to a previous time, the content source accessed by the most devices within the geographic region, or others. In various examples, predictive knowledge system may determine a content source associated with the particular geographic region on any of a number of criteria, such as a current time of day, a type of computing device 10, a type of content provided by each content source, or other criteria. In the example of FIG. 1, predictive knowledge system 6 may determine, as a content resource, content provider system 20, which is associated with the URL www.skivillehills.com.

Predictive knowledge system 6, in the example of FIG. 1, may receive, from the content source, content designated for use by the predictive knowledge system. For instance, computing system 4 may send (e.g., via network 25) a request for content to content provider system 20. The request for content may be a request formatted in accordance with any applicable protocol, such as a GET request of the Hypertext Transfer Protocol (HTTP), requesting the webpage of www.skivillehills.com. Responsive to receiving the request, content provider system 20 may send (e.g., via network 25) content 28 to predictive knowledge system 6 of computing system 4.

Content 28, in the example of FIG. 1, may be HTML data and/or other data for a webpage. In some examples, content 28 may be other types of data, such as eXtensible Markup Language (XML) data, Javascript data, etc. A portion of content 28 may be designated for use by predictive knowledge system 6. Another portion of content 28, however, may be content that is not designated for use by predictive knowledge system 6. For instance, if content 28 represents a webpage for www.skivillehill.com, content 28 may include, in a header section of the webpage, content that is designated for use by predictive knowledge system 6. The content designated for use by predictive knowledge system 6 may include ski trail information for Skiville Hill Ski Area, located just north of Skiville, Colo.

If the webpage at www.Skivillehill.com were to be displayed by a conventional web browser application, the content designated for use by predictive knowledge system 6 may not be displayed or otherwise available. In other words, the techniques described herein my enable content providers to create their own content for use by predictive knowledge system 6 without having to otherwise set up and/or manage additional content sources. Instead, content providers can utilize existing venues (e.g., webpages) to provide additional content for use by predictive knowledge system 6.

In some examples, the portion of content 28 that is designated for use by predictive knowledge system 6 may be designated by including the content within a structure defined by predictive knowledge system 6. We retrieving content from the content source, predictive knowledge system 6 may parse the content and extract the content included in the structure for inclusion in data pushed by predictive knowledge system 6. In the example of FIG. 1, predictive knowledge system 6 may send, to computing device 10, at least a portion of the content for display. For instance, predictive knowledge system 6 may extract, from content 28, the content that is designated for use by predictive knowledge system 6. In some examples, predictive knowledge system 6 may perform various reformatting or sanitization techniques on the content designated for use by predictive knowledge system 6, such as scanning the content for malicious code, ensuring the content adheres to certain definitions (e.g., schema), or other such techniques. Predictive knowledge system 6 may output the extracted portion of the content for sending to computing device 10. One or more communications devices of computing system 10 may send (e.g., via network 25) content portion 30.

Computing device 10 may receive content portion 30 and, in response, may output an indication of the received content portion. For instance, computing device 10 may output an indication of the content portion for display as part of a graphical user interface (GUI). As one example, computing device 10 may display GUI 32 as shown in the example of FIG. 1. GUI 32 represents one example of a predictive knowledge application interface.

As shown in the example of FIG. 1, GUI 32 includes information card 34. Information card 34 includes image 36 and text box 38. Image 36 and text box 38 may represent content created and provided by content provider system 20, but delivered by predictive knowledge system 6 of computing system 4. In some examples, card 34 may be displayed in accordance with a structure defined by predictive knowledge system 6. For instance, content provider system 20 may include, in the portion of content 28 that is designated for use by predictive knowledge system 6, a definition indicating that image 36 should be displayed as the background of information card 34. As another example, content provider system 20 may include, in the portion of content 28 that is designated for use by predictive knowledge system 6, a definition indicating that text 38 should be displayed in a text box in the center of information card 34.

A predictive knowledge system configured in accordance with the techniques described herein may enable third party content providers to create and designate content for use by the predictive knowledge system. Enabling third parties to create content for a predictive knowledge system in a distributed fashion may reduce the computational requirements and administrative management necessary to create such content. The techniques of the present disclosure maintain control over when such third party content is provided to users, however, thereby reducing the risk that third party content providers or others may attempt to provide content to users that is not immediately relevant or may be otherwise undesirable. Furthermore, by maintaining a centralized predictive knowledge system, the techniques described herein do not require users to install and/or use multiple applications to obtain relevant, timely information from multiple sources. In this way, the techniques of this disclosure may enable a more efficient and unified user experience while opening up a predictive knowledge system to third party content.

FIG. 2 is a block diagram illustrating one example of computing system 4, configured to provide contextual delivery of relevant third party content, in accordance with one or more techniques of the present disclosure. Computing system 4 may include hardware, firmware, software, or any combination thereof. In the example of FIG. 2, computing system 4 may comprise a hardware device, such as a server computer, having various hardware, firmware, and software components. FIG. 2 illustrates only one particular example of computing system 4, and many other examples of computing system 4 may be used in accordance with the techniques of the present disclosure.

As shown in the specific example of FIG. 2, computing system 4 includes one or more processors 40, one or more communications units 42, and one or more storage devices 44. Stored at storage devices 44, computing system 44 further includes predictive knowledge system 6, aggregated web access history 8, geographic regions 48, regional content sources 49, and content cache 50. Predictive knowledge system 6 includes history management module 52, region management module 54, and content management module 56. While shown as a single computing system in the example of FIG. 2, computing system 4 may, in other examples, include one or more components located in different locations (e.g., connected via network 25 of FIG. 1). That is, in some examples, computing system 4 may be a conventional computing system, while in other examples, computing system 4 may be a distributed or “cloud” computing system.

Each of components 40, 42, and 44 may be interconnected (physically, communicatively, and/or operatively) for inter-component communications. In the example of FIG. 2, components 40, 42, and 44 may be coupled by one or more communications channels (COMM. CHANNELS) 46. In some examples, communications channels 46 may include a system bus, network connection, inter-process communication data structure, or any other channel for communicating data. In other examples, such as where computing system 4 is a distributed computing system or cloud-based computing system, communications channels 46 may include one or more network connections, such as portions of network 25 of FIG. 1. Predictive knowledge system 6, aggregated web access history 8, geographic regions 48, regional content sources 49, content cache 50, and/or modules 52, 54, and 56 may also communication information with one another as well as with other components of computing system 4.

Processors 40, as shown in the example of FIG. 2, may be configured to implement functionality and/or process instructions for execution within computing system 4. For example, processors 40 may be capable of processing instructions stored in storage devices 44. Examples of processors 40 may include, any one or more of a microprocessor, a controller, a digital signal processor (DSP), an application specific integrated circuit (ASIC), a field-programmable gate array (FPGA), or equivalent discrete or integrated logic circuitry.

In the example of FIG. 2, communications units 42 may be configured to communicate with external devices via one or more networks, such as network 25 of FIG. 1. Communications units 42 may include a network interface card, such as an Ethernet card, an optical transceiver, a radio frequency transceiver, or any other type of device that can send and receive information. Other examples of such network interfaces may include Bluetooth, 3G, and WiFi radio components, as well as Universal Serial Bus (USB) interfaces. In some examples, computing system 4 may utilize communications units 42 to wirelessly communicate with one or more external devices such as computing device 10 and/or content provider system 20 of FIG. 1.

Storage devices 4 may, in the example of FIG. 2, be operable to store information for processing during operation of computing system 4. For instance, computing system 4 may store data that processors 40 may access to execute one or more programs. In some examples, storage devices 44 represent temporary memories, meaning that a primary purpose of storage devices 44 is not long-term storage. For instance, storage devices 44 of computing system 4 may be volatile memory, meaning that storage devices 44 may not retain stored contents if powered off. Examples of volatile memories include random access memories (RAM), dynamic random access memories (DRAM), static random access memories (SRAM), and other forms of volatile memories known in the art.

Storage devices 44, in some examples, also include one or more computer-readable storage media. As such, storage devices 44 may be configured to store larger amounts of information than volatile memory. Storage devices 44 may further be configured for long-term storage of information. In some examples, storage devices 44 include non-volatile storage elements, meaning that storage devices 44 may maintain information through power on/power off cycles. Examples of non-volatile memories include magnetic hard discs, optical discs, floppy discs, flash memories, or forms of electrically programmable memories (EPROM) or electrically erasable and programmable (EEPROM) memories. Storage devices 44 may, in some examples, store program instructions and/or information (e.g., data) associated with predictive knowledge system 6, and modules 52, 54, and/or 56, such as during program execution.

In some examples, computing system 4 may include other components not shown in the example of FIG. 2. For instance, computing system 4 may include one or more input devices, such as devices configured to receive input from a user through tactile, audio, or video feedback, and/or one or more output devices, such as devices to provide output to a user using tactile, audio, or video stimuli.

In the example of FIG. 2, history management module 52 of predictive knowledge system 6 may be operable to generate and/or maintain aggregated web access history 8. Aggregated web access history 8 may represent a collection of data (e.g., a database or other data structure(s)) indicating content sources accessed by one or more users and a respective geographic location from which each content source was accessed. That is, aggregated web access history 8 may be a record of content sources accesses. An access of a content source may be any action that causes interaction with the content source. For instance, clicking on a link in a web browser or entering a URL into the web browser may represent accessing the relevant webpage. Other examples of accessing content sources may include opening an application (e.g., an “app”), sending or receiving a message (e.g., text message, email, etc.) to a content source or user associated with the content source, downloading songs or other media from a content source, or other contact with a content source.

As such, aggregated web access history 8 may, in some examples, be a set of content sources (e.g., URLs) and respective locations (e.g., latitude and longitude coordinates) from which each content source was accessed. Aggregated web access history 8 may, in some examples, include additional information about the content source accesses, such as a time at which the content source was accessed, an amount of data transferred to and/or from the content source, a type of device that accessed the content source, or other information.

History management module 52 may generate and/or maintain aggregated web access history 8 using access information received from one or more computing devices. For instance, computing system 4 may periodically receive (e.g., via network 25 of FIG. 1) information from a computing device that specifies one or more content source accesses performed by the computing device, a location at which the computing device was located when the content source was accessed, and a time at which the content source was accessed. History management module 52 may receive such information from multiple computing device and aggregate and store the information in aggregated web access history 8. In some examples, history management module 52 may remove or modify information stored in aggregated web access history 8. For instance, history management module 52 may remove information about content source accesses that is older than a threshold amount of time (e.g., 1 week, 1 month, 1 year, etc.).

Region management module 54, in the example of FIG. 2, may be operable to generate and/or maintain geographic regions 48. Geographic regions 48 may represent a collection of data (e.g., a database or other data structure(s)) defining one or more geographic regions. For instance, geographic regions 48 may be a database having entries that each describes a particular geographic region.

Geographic regions may specify portions of the physical world. Within geographic regions 48, geographic regions may, in some examples, be defined using geometry. For instance, a geographic region may be defined in geographic regions 48 using a geographic location (e.g., latitude and longitude values) and a distance value that represents a radius around the location. In some examples, a geographic region within geographic regions 48 may be defined using a plurality of geographic locations, each defining a point on a perimeter of the geographic region. For instance, a geographic region may be a quadrangle region defined using four geographic locations as the vertices of the quadrangle. In some examples, geographic regions may be defined within geographic regions 48 using various other geometric definitions. In some examples, the geographic regions defined by geographic regions 48 may be distinct from one another while in other examples, some geographic regions may be overlapping. Geographic regions may, in some examples, be hierarchical. That is, some geographic regions may be entirely included in other geographic regions.

In some examples, region management module 54 of predictive knowledge system 6 may generate and/or maintain geographic regions 48 based on aggregated web access history 8. For instance, region management module 54 may access aggregated web access history 8 and determine locations from which a particular content source was accessed by computing devices. Based on the determined locations, region management module 54 may define, within geographic regions 48, a region that includes the determined locations. As another example, region management module 54 may perform machine learning techniques to define regions within geographic regions 48 based on what content sources were accessed, locations from which the content sources were accessed, and/or a time at which the content sources were accessed.

In some examples, region management module 54 may periodically update and/or modify geographic regions 48 based on aggregated web access history 8. For instance, region management module 54 may access aggregated web access history 8 to obtain newly aggregated information. Based on the new information, region management module 54 may update, modify, and/or remove regions defined within geographic regions 48.

While described in the example of FIG. 2, as being generated and/or maintained by one or more components of computing system 4, aggregated web access history 8 and/or geographic regions 48 may, in some examples, be pre-configured. As one example, aggregated web access history 8 may be determined by another computing system (not shown) and installed or stored at computing system 4. As another example, geographic regions 48 may be a collection of pre-defined, static regions, such as regions representing countries, states, provinces, prefectures, counties, metro areas, cities, towns, census blocks, and/or other pre-defined regions. For instance, geographic regions 48 may include a geocoded database of areas previously defined by political boundaries, geographic boundaries, or other boundaries.

In the example of FIG. 2, region management module 54 may be operable to generate and maintain regional content sources 49. Regional content sources 49 may represent a collection of data (e.g., a database or other data structure(s)) indicating, for each region defined within geographic regions 48, one or more content sources that are associated with the region. That is, regional content sources 49 may specify, for each geographic region, one or more associated content sources.

Region management module 54 may determine content sources to associate with a particular geographic region based on aggregated web access history 8. For instance, region management module 54 may access aggregated web access history 8 to determine all content sources accessed from within the particular geographic region. In some examples, region management module 54 may associate all of the content sources that were accessed from within the particular geographic region with the particular geographic region. That is, in some examples regional content sources 49 may indicate, as associated content sources for a particular geographic region, all content sources accessed from the particular geographic region. In some examples, however, region management module 54 may select only a portion of the content sources accessed from within the particular geographic region for association with the particular geographic region.

In some examples, region management module 54 may select content sources to associate with a particular geographic region based additionally or alternatively on respective popularity scores that are associated with each of the content sources. The popularity score that is associated with a content source may be a measure of how popular the content source is with users in the geographic region. Thus, a content source may have different popularity scores for different geographic regions.

Region management module 54 may determine a content source's associated popularity score for a particular region based on various criteria, such as the overall number of times that the content source was accessed from within the particular geographic region, the number of times that the content source was accessed from within the particular geographic region within a specified duration of time (e.g., within the past hour, within the past day, within the past week, etc.), a frequency with which the content source was accessed from within the particular geographic region, whether and how often the content source was accessed from within geographic regions other than the particular geographic region, or other criteria. The more a content source is accessed and/or the more often the content source is accessed, the better the popularity score that is associated with the content source may be.

In some examples, region management module 54 may additionally or alternatively determine popularity scores based on feedback from users. For instance, predictive knowledge system 6 may provide content obtained from a content source to one or more users. Thereafter, predictive knowledge system 6 may receive feedback from the users regarding the applicability of provided content. As one example, the user may input a selection or dismissal of a user interface element that includes the content. The computing device may send an indication of the selection or dismissal to computing system 4. Based on the selection or dismissal, region management module 54 may increase or decrease the content source's popularity score accordingly. Region management module 54 may store an indication of the particular geographic region, its associated content sources, and/or determined popularity scores in regional content sources 49.

In the example of FIG. 2, content management 56 may be operable to generate and/or maintain content cache 50. Content cache 50 may store a cached version of content, received from a content provider, which is designated for use by predictive knowledge system 6, as well as a time at which the cached version was stored. That is, when predictive knowledge system 6 receives content from a content provider (e.g., content provider system 20 of FIG. 1), content management module 56 may store or update the portion of content designated for use by predictive knowledge system 6 in content cache 50.

In accordance with the techniques described herein, predictive knowledge system 6 of computing system 4 may access aggregated web access history 8, geographic regions 48, regional content sources 49, and/or content cache 50 in order to provide third party content that is relevant to a user's current location to the user's computing device in a predictive fashion. For example, predictive knowledge system 6 of computing system 4 may receive an indication of a current location of a computing device. For instance, communications units 42 of computing system 4 may periodically receive data (e.g., via network 25 of FIG. 1) indicating current locations of computing device 10 of FIG. 1. Communications units 42 may provide the data to predictive knowledge system 6 (e.g., via communications channels 46).

Based on the current location of computing device 10, predictive knowledge system 6 may access geographic regions 48 to determine a particular geographic region that includes the current location of computing device 10. In some examples, predictive knowledge system 6 may determine that the current location of computing device 10 is not included in any of the geographic regions defined within geographic region store 48. In such instance, predictive knowledge system 6 may do nothing, or perform other operations. In some examples, however, predictive knowledge system 6 may determine that the current location of computing device 10 is within one or more geographic regions.

When geographic region store 48 includes only non-overlapping regions, predictive knowledge system 6 may determine a single geographic region that includes the current location of computing device 10. In other examples (e.g., when geographic region store 48 includes overlapping regions), predictive knowledge system 6 may determine one or more geographic regions that include the current location of computing device 10. In some such examples, predictive knowledge system 6 may select only one of the geographic regions that include the current location of computing device 10 or a number (e.g., 2, 3, etc.) of the geographic regions that include the current location of computing device 10. As one example, predictive knowledge system 6 may select from the geographic regions that include the current location based on a size of the geographic regions. For instance, predictive knowledge system 6 may select the smallest geographic region that includes the current location, the smallest two geographic regions that include the current location, etc. In some examples, predictive knowledge system 6 may select from the geographic regions that include the current location based on other criteria, such as how close the current location is to a centroid of each geographic region.

Based on the selected geographic region (or regions), predictive knowledge system 6 may determine one or more content sources associated with the selected geographic region (or regions). That is, predictive knowledge system 6 may access regional content sources 49 and determine, for the selected geographic region, one or more content sources associated with the selected region.

After determining the content source (or sources), predictive knowledge system 6 may obtain, from the content source, content designated for use by predictive knowledge system 6. For instance, predictive knowledge system 6 may generate a request for content and communications units 42 may send the request to the content source. In response, predictive knowledge system 6 may receive the requested content. The received content may include content not designated for use by predictive knowledge system 6 and the content designated for use by predictive knowledge system 6. For instance, the received content may be a webpage that includes the content designated for use by predictive knowledge system 6 in a header of the webpage. As another example, the content may be an application module and the content designated for use by predictive knowledge system 6 may be included in metadata about the application module.

After receiving the content from the content source, predictive knowledge system 6 may extract the content designated for use by predictive knowledge system 6. The content designated for use by predictive knowledge system 6 may include at least one structural definition for the content designated for use by predictive knowledge system 6. That is, the content designated for use by predictive knowledge system 6 may include information indicating a manner in which the content designated for use by predictive knowledge system 6 is to be displayed by a computing device. Examples of structural definitions that may be included in the content designated for use by predictive knowledge system 6 include an indication of a font, font size, or font style in which a text portion of the content is to be displayed, an indication of an alignment at which the text portion is to be displayed, an indication of how a background image of the content is to be displayed (e.g., stretched, tiled, centered, etc.), or any other information specifying how the content designated for use by predictive knowledge system 6 is to be displayed by a computing device.

In some examples, predictive knowledge system 6 may determine a level of recentness of the content designated for use by predictive knowledge system 6. For instance, predictive knowledge system 6 may access content cache 50 to determine whether the content designated for use by predictive knowledge system 6 has changed recently. That is, predictive knowledge system 6 may compare the content designated for use by predictive knowledge system 6 to a version of the content stored in content cache 50 to determine the level of recentness of the content designated for use by predictive knowledge system 6.

If the received content is different from the stored version and/or if there is only a small time difference between a time at which the stored version was stored and the current time, predictive knowledge system 6 may determine that the level of recentness for the content designated for use by predictive knowledge system 6 satisfies a threshold level of recentness, and that the content is thus likely relevant to users. The threshold level of recentness may be any reasonable time period that defines a level of recentness, such as one hour, one day, one month, or other time period. That is, predictive knowledge system 6 may determine that a level of recentness satisfies the threshold if the content designated for use by predictive knowledge system 6 has changed in the past hour, the past day, the past month, etc. In some examples, the threshold level of recentness may vary based on the type of content or other factors.

If the received content is different from the stored version, predictive knowledge system 6 may update content cache 50 my replacing the stored version of the content with the received version. If the received content is not different from the stored version, predictive knowledge system 6 may not modify content cache 50. This may ensure that subsequent checks provide an accurate determination of the level of recentness for the content.

If the level of recentness for the content designated for use by predictive knowledge system 6 is sufficiently high, predictive knowledge system 6 may cause communications units 42 to send, to the computing device, at least a portion of the content designated for use by predictive knowledge system 6 with instructions to display the content in accordance with any structural definitions included therein. The computing device may receive the content and the instructions and display the content, in accordance with the received structural definitions, as part of a GUI. For instance, the computing device may display the received content as a user interface element (e.g., a card) of a predictive knowledge application executing at the computing device.

By obtaining, from one or more content sources, content designated for use by a predictive knowledge system and providing at least a portion of the content designated for use by the predictive knowledge system to a computing device for display, computing system 4 may enable third parties to create and provide a wide variety of content in a predictive manner without a user of the computing device having to request or otherwise indicate a desire for the content. Furthermore, by determining, based on a current location of the computing device, from which content sources to obtain the content designated for use by the predictive knowledge system, computing system 4 may ensure that the third party content provided to the computing device is likely to be relevant to the user of the computing device and avoid possible issues that may arise from allowing third parties to determine potential relevancy of content.

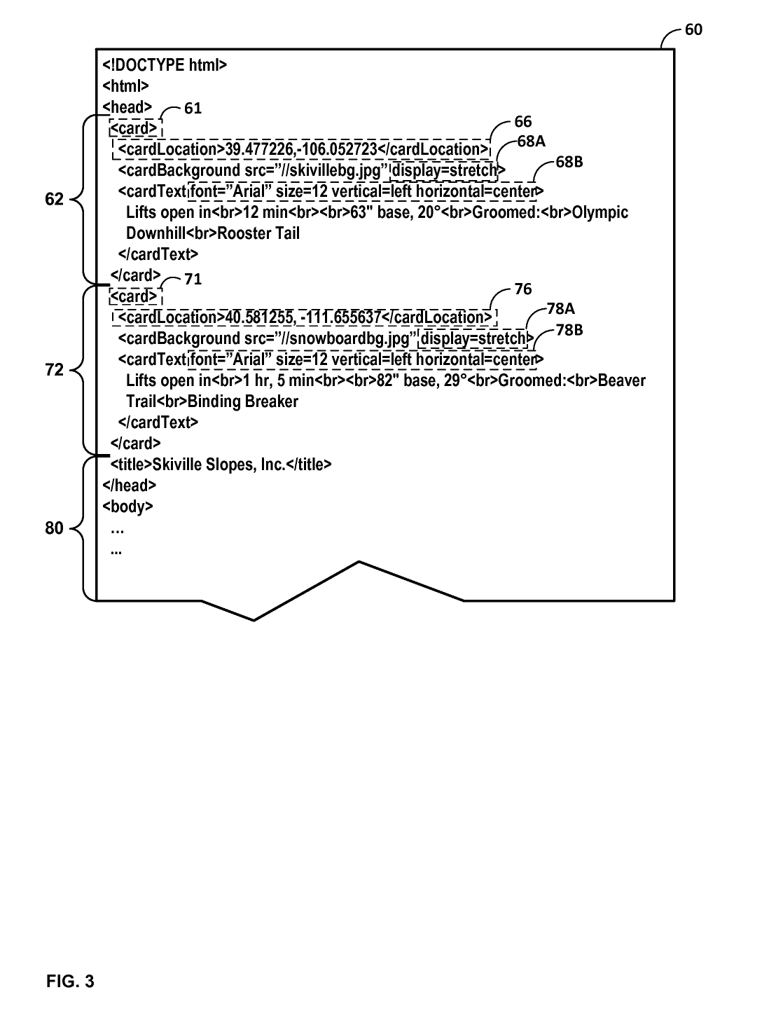

FIG. 3 is a block diagram illustrating example content 60 received from a content source, in accordance with one or more techniques of the present disclosure. For purposes of illustration only, the example of FIG. 3 is described below within the context of FIGS. 1 and 2.

In the example of FIG. 3, content 60 may represent one example of content 28 received from content provider system 20. For instance, predictive knowledge system 6 of computing system 4 may receive current location 26 from computing device 10 and determine a particular geographic region that includes the current location. Predictive knowledge system 6 may determine a content source associated with the particular geographic region, such as content provider system 20. Predictive knowledge system 6 may generate and send, to content provider system 20, a request for content. For instance, the request for content may be an HTTP GET request indicating the content source URL. In response to the request, predictive knowledge system 6 may receive content 60.

As shown in the example of FIG. 3, content 60 is an HTML document that represents a webpage. Content 60 includes content portion 80, which is not designated for use by predictive knowledge system 6. Content portion 80 may be usable by other applications (e.g., a web browser) to display a webpage or be used in some other fashion.

Content 60 also includes content portions 62, 72, which are designated for use by predictive knowledge system 6. Content portions 62 and 72 may be designated for use by predictive knowledge system 6 by the inclusion of designators 61 and 71, respectively. That is, designator 61 and designator 71 (e.g., and the respective closing tags) may specify content that is designated for use by predictive knowledge system 6. While shown in the example of FIG. 3 as a set of tags, content may be designated for use by predictive knowledge system 6 in other ways as well, such as by the location in content 60 at which the content appears.

In the example of FIG. 3, content portions 62 and 72 include location indicators 66 and 76, respectively. Location indicators 66 and 76 may indicate a corresponding geographic area or location for which the respective content portion is designated for use. That is, location indicator 66 may indicate a geographic area or location for which content portion 62 is designated for use by predictive knowledge system 6 and location indicator 76 may indicate a geographic area or location for which content portion 72 is designated for use by predictive knowledge system 6. In the example of FIG. 3, location indicators 66 and 76 may specify latitude and longitude values of a geographic location. In some examples, location indicators may specify a geographic area or location using a geometric definition, a landmark reference, or other indication of a location.

When received content includes a plurality of content portions designated for use by predictive knowledge system 6, predictive knowledge system 6 may determine a particular content portion, from the plurality of content portions, to send to computing device 10 for display. Predictive knowledge system 6 may determine the particular content portion based at least in part on the geographic areas or geographic locations for which each content portion is designated. For instance, predictive knowledge system 6 may determine which content portion is designated for use in a location that corresponds to the particular geographic region that includes the current location of computing device 10. As another example, predictive knowledge system 6 may determine which content portion is designated for use at a location that is closest to the current location of computing device 10. In some examples, predictive knowledge system 6 may determine the particular content portion based on other criteria, such as a measured popularity of each content portion in the particular geographic region that includes the current location of computing device 10. In other words, predictive knowledge system 6 may determine the content portion that is likely to be relevant to a user of computing device 10.

In the example of FIG. 3, content portions 62 and 72 include structural definitions 68A, 68B, and 78A, 78B, respectively. Structural definitions 68A, 68B, and 78A, 78B may indicate a manner in which the respective content designated for use by predictive knowledge system 6 is to be displayed by a computing device (e.g., computing device 10). That is, structural definitions, generally, may specify how content should be displayed as part of a predictive knowledge application executing at a computing device. In the example of FIG. 3, for instance, structural definition 68A may specify that the indicated background image “skivillebg.jpg” should be stretched to fill the user interface element that will include content portion 61. Similarly, structural definition 78A may specify that the indicated background image “snowboardbg.jpg” should be stretched to fill the user interface element that will include content portion 71. Structural definitions 68B and 78B may specify a font type, a font size, and horizontal and vertical alignments of the text portion of content portions 61 and 71, respectively. When sending at least a portion of content portion 61 and/or content portion 71 to computing device 10 for display, predictive knowledge system 6 may include indications of structural definitions 68A, 68B, and/or 78A, 78B in order to cause computing device 10 to predictively output the information in accordance with structural definitions 68A, 68B, and/or 78A, 78B.

While shown in the example of FIG. 3 as including two separate content portions designated for use by predictive knowledge system 6, received content may, in various examples, include any number of separate content portions. For instance, a zoo feeding website may include a large number of content portions designated for use by predictive knowledge system 6, with each content portion corresponding to a different animal exhibit. In this way, third party content providers may provide multiple different types of predictive content without needing to create multiple webpages or other content sources.

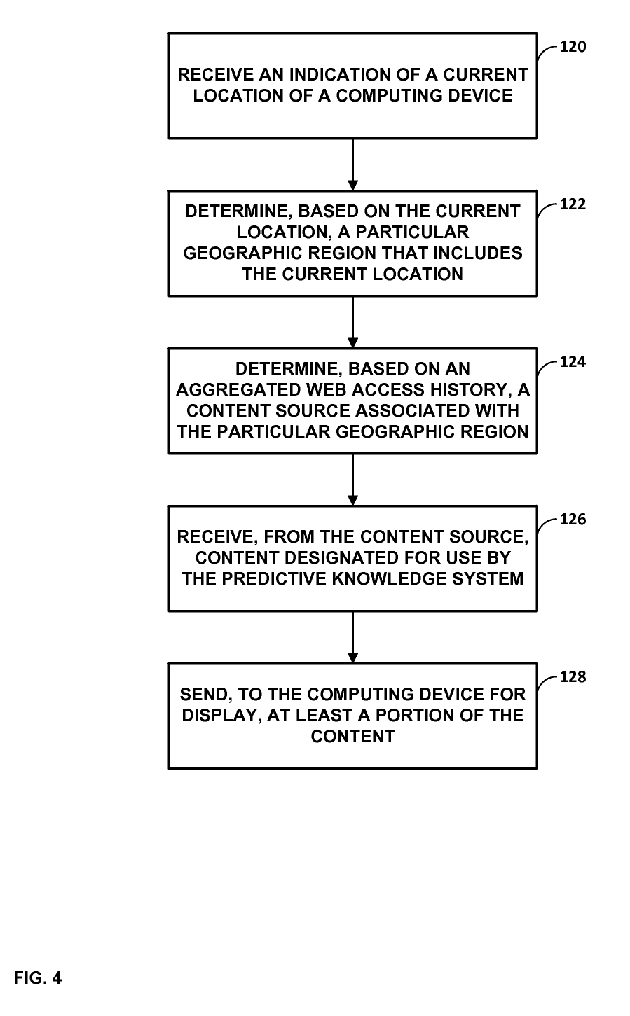

FIG. 4 is a flow diagram illustrating example operations of a computing system configured to provide contextual delivery of relevant third party content, in accordance with one or more techniques of the present disclosure. For purposes of illustration only, the example operations of FIG. 4 are described below within the context of FIGS. 1 and 2.

In the example of FIG. 4, a predictive knowledge system (e.g., predictive knowledge system 6 executing at computing system 4) may receive an indication of a current location of a computing device, such as computing device 10 (120). Based at least in part on the current location, predictive knowledge system 6 may determine, from a plurality of defined geographic regions, a particular geographic region that includes the current location (122). In some examples, predictive knowledge system 6 may determine more than one particular geographic region. In other examples, predictive knowledge system 6 may determine only a single particular geographic region.

Predictive knowledge system 6, in the example of FIG. 4, may determine, based on an aggregated web access history (e.g., aggregated web access history 8 of computing system 4), a content source associated with the particular geographic region (124). For instance, predictive knowledge system 6 may determine a URL associated with the particular geographic region. In some examples, predictive knowledge system 6 may determine more than one content source. In other examples predictive knowledge system 6 may determine a single content source that is associated with the particular geographic region.

In the example of FIG. 4, predictive knowledge system 6 may receive, from the content source, content designated for use by the predictive knowledge system (126). For instance, predictive knowledge system 6 may generate and send a request for content, such as an HTTP request for a webpage located at the URL. In response to the request, predictive knowledge system 6 may receive the webpage. The webpage may include both content that is not designated for use by predictive knowledge system 6 (e.g., code defining a webpage for use by a web browser), and content designated for use by predictive knowledge system 6. As an example of content designated for use by predictive knowledge system 6, the webpage may include code (e.g., in a header area) defining one or more user interface elements to be sent, by predictive knowledge system 6, to a computing device for presentation by a predictive knowledge application executing at the computing device.

Predictive knowledge system 6, in the example of FIG. 4, may send, to computing device 10 for display, at least a portion of the content designated for use by predictive knowledge system 6 (128). For instance, predictive knowledge system 6 may send at least a portion of the code defining the one or more user interface elements. Computing device 10 may receive the content and output the content for display. For example, computing device 10 may display information card 34 as part of GUI 32. In this way, predictive knowledge system 6 of computing system 4 may enable third parties to provide predictive content to users while ensuring that content provided to users is likely to be relevant.

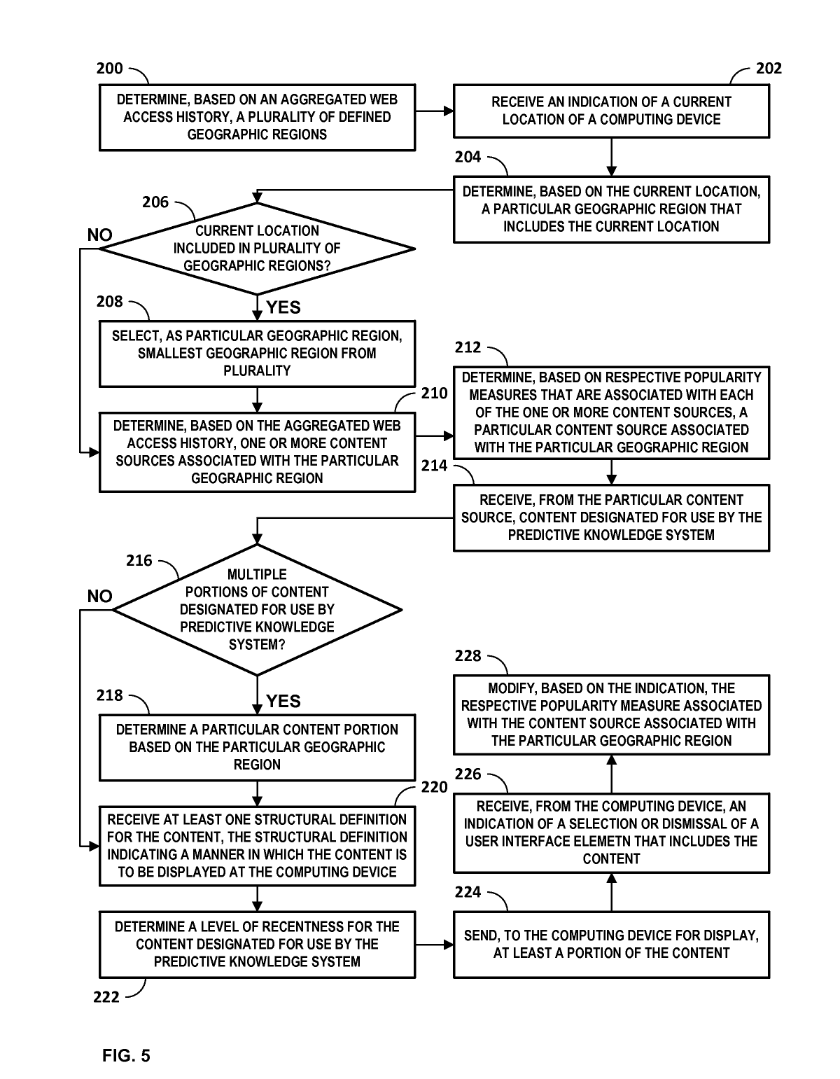

FIG. 5 is a flow diagram illustrating example operations of a computing system configured to provide contextual delivery of relevant third party content, in accordance with one or more techniques of the present disclosure. For purposes of illustration only, the example operations of FIG. 5 are described below within the context of FIGS. 1 and 2.

In the example of FIG. 5, a predictive knowledge system (e.g., predictive knowledge system 6 executing at computing system 4) may determine, based on an aggregated web access history, a plurality of defined geographic regions (200). The aggregated web access history may, in some examples, include indications of content sources accessed by computing devices and geographic locations at which the computing devices were located when they accessed the content sources.

Predictive knowledge system 6 may, in the example of FIG. 5, receive an indication of a current location of a computing device (202). For instance, predictive knowledge system 6 may receive a current location of computing device 10 via network 25. The indication of the current location may, in some examples, be latitude and longitude values representing the current location. Based on the current location, predictive knowledge system 6 may determine a particular geographic region that includes the current location (204). In some examples, predictive knowledge system 6 may determine that the current location is included in a plurality of geographic regions (206). If the current location of computing device 10 is included in a plurality of geographic regions (“YES” branch of operation 206), predictive knowledge system 6 may select, in some examples, select one or more geographic regions from the plurality. For instance, in the example of FIG. 5, predictive knowledge system 6 may select, as the particular geographic region, a smallest geographic region from the plurality (208). If the current location of computing device 10 is not included in a plurality of geographic regions (“NO” branch of operation 206), predictive knowledge system 6 may not need to make the selection.

In the example of FIG. 5, predictive knowledge system 6 may determine, based on the aggregated web access history, one or more content sources associated with the particular geographic region (210). In the example of FIG. 5, for instance, predictive knowledge system 6 may determine a plurality of content sources associated with the particular geographic region. In such example, predictive knowledge system 6 may determine a particular content source associated with the particular geographic region based on respective popularity measures that are associated with each of the one or more content sources (212).

Predictive knowledge system 6, in the example of FIG. 5, may receive, from the particular content source, content designated for use by predictive knowledge system 6 (214). For instance, predictive knowledge system 6 may generate and send a request for content (e.g., an HTTP GET request) and receive content in response to the request. In some examples, the received content may include both content designated for use by predictive knowledge system 6 and content that is not designated for use by predictive knowledge system 6.

In the example of FIG. 5, predictive knowledge system 6 may determine whether the received content includes multiple portions of content designated for use by predictive knowledge system 6 (216). That is, predictive knowledge system 6 may determine whether the content received from the content source includes multiple portions or instances of content designated for use by predictive knowledge system 6, with each portion or instance corresponding to a different geographic region or location. If the content includes multiple portions of content designated for use by predictive knowledge system 6 (“YES” branch of operation 216), predictive knowledge system 6 may determine a particular content portion based on the particular geographic region (218). That is, predictive knowledge system 6 may determine which content portion corresponds to the current location of computing device 10. If the content includes only one portion of content designated for use by predictive knowledge system 6 (“NO” branch of operation 216), predictive knowledge system 6 may not need to determine a particular portion.

Predictive knowledge system 6, in the example of FIG. 5, may also receive at least one structural definition for the content designated for use by predictive knowledge system 6 (220). The at least one structural definition may indicate a manner in which the content designated for use by predictive knowledge system 6 is to be displayed at a computing device (e.g., computing device 10). In some examples, the at least one structural definition may be included in the content designated for use by predictive knowledge system 6. In some examples, the at least one structural definition may be separate from the content designated for use by predictive knowledge system 6.

In the example of FIG. 5, predictive knowledge system 6 may determine a level of recentness for the content designated for use by predictive knowledge system 6 (222). For instance, predictive knowledge system 6 may compare the received content designated for use by predictive knowledge system 6 to a cached version of the content. If the two are different, or if a difference between the time at which the cached version was stored and the current time is sufficiently small, predictive knowledge system 6 may send, to computing device 10, at least a portion of the content for display in accordance with the at least one structural definition (224). A predictive knowledge application of computing device 10 may output the content for display in accordance with the at least one structural definition within a user interface element as part of a GUI.

Predictive knowledge system 6, in the example of FIG. 5, may receive, from computing device 10, an indication of a selection or dismissal of the user interface element that includes the content (226). For instance, a user of computing device 10 may find the content irrelevant or undesired, and may dismiss the user interface element that includes the content. Based on the received indication, predictive knowledge system 6 may modify a respective popularity measure that is associated with the content source associated with the particular geographic region (228). In this way, predictive knowledge system 6 may ensure that subsequent determinations of content sources associated with the particular geographic region are less likely to predictively provide content from the content source to users in the particular geographic region.

Appended to this description is a plurality of claims directed to various embodiments of the disclosed subject matter. It will be appreciated that embodiments of the disclosed subject matter may also be within the scope of various combinations of said claims, such as dependencies and multiple dependencies therebetween. Therefore, by reference thereto, all such dependencies and multiple dependencies, explicit or otherwise, form a portion of this description.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
receiving, by a predictive knowledge system executing on a computing system, an indication of a current location of a computing device;
determining, by the predictive knowledge system, based at least in part on the current location of the computing device, a particular geographic region from a plurality of defined geographic regions, the particular geographic region including the current location of the computing device;
determining, by the predictive knowledge system, based on an aggregated web access history for a plurality of computing devices, a content source associated with the particular geographic region;
receiving, by the predictive knowledge system, from the content source, content designated for use by the predictive knowledge system; and
sending, by the predictive knowledge system, to the computing device, at least a portion of the content designated for use by the predictive knowledge system.

2. The method of claim 1, further comprising:
receiving, from the content source, at least one structural definition for the content designated for use by the predictive knowledge system, the at least one structural definition indicating a manner in which the content designated for use by the predictive knowledge system is to be displayed at the computing device,
wherein sending the at least a portion of the content comprises sending, to the computing device, the portion of the content for display in accordance with the at least one structural definition.

3. The method of claim 2, wherein the at least one structural definition comprises at least one of:
an indication of a font in which a text portion of the content designated for use by the predictive knowledge system is to be displayed by the computing device;
an indication of a font style in which the text portion of the content designated for use by the predictive knowledge system is to be displayed by the computing device; or
an indication of how a background image of the content designated for use by the predictive knowledge system is to be displayed by the computing device.

4. The method of claim 1, wherein receiving the content designated for use by the predictive knowledge system comprises receiving a webpage that includes the content designated for use by the predictive knowledge system in a header area of the webpage.

5. The method of claim 1, further comprising:
determining a level of recentness for the content,
wherein sending at least a portion of the content comprises sending at least a portion of the content in response to determining that the level of recentness satisfies a threshold.

6. The method of claim 5, further comprising:
storing, by the predictive knowledge system, a version of the content,
wherein determining the level of recentness for the content comprises determining the level of recentness based on at least one of: a time at which the version of the content was stored, a current time, the version of the content, or the content.

7. The method of claim 1, wherein the aggregated web access history comprises respective indications of one or more content sources previously accessed by the plurality of computing devices and respective geographic locations from which the one or more content sources were accessed, the method further comprising:
determining, by the predictive knowledge system and based at least in part on the aggregated web access history, the plurality of defined geographic regions.

8. The method of claim 1, wherein determining the content source associated with the particular geographic region comprises:
determining, by the predictive knowledge system and for the particular geographic region, a plurality of content sources associated with the particular geographic region, wherein a respective popularity measure is associated with each content source from the plurality of content sources; and
determining, by the predictive knowledge system and based at least in part on the respective popularity measures, the content source associated with the particular geographic region.

9. The method of claim 8, further comprising:
receiving, by the predictive knowledge system, from the computing device, an indication of at least one of: a selection of a user-interface element that includes the content, or a dismissal of the user-interface element; and
responsive to receiving the indication, modifying, by the predictive knowledge system and based on the indication, the respective popularity measure associated with the content source associated with the particular geographic region.

10. The method of claim 1, wherein determining the particular geographic region comprises:
determining, by the predictive knowledge system, a subset of geographic regions from the plurality of defined geographic regions, each geographic region from the subset of geographic regions including the current location; and
selecting, as the particular geographic region, a smallest geographic region from the subset of geographic regions.

11. The method of claim 1, wherein receiving the content designated for use by the predictive knowledge system comprises receiving a plurality of content portions and indications of corresponding geographic locations for which each of the plurality of content portions are designated for use, the method further comprising:
determining, based at least in part on the particular geographic region and the corresponding geographic locations for which each of the plurality of content portions are designated for use and, a particular content portion from the plurality of content portions,
wherein sending at least a portion of the content comprises sending the particular content portion.

12. The method of claim 1, wherein sending at least a portion of the content comprises sending at least a portion of the content without first receiving, from the computing device, a request that specifies the content.

13. A computing system, comprising:
at least one processor;
a communication unit configured to receive, from a computing device, an indication of a current location of the computing device; and
a predictive knowledge system operable by the at least one processor to:
determine, based at least in part on the current location of the computing device, a particular geographic region from a plurality of defined geographic regions, the particular geographic region including the current location of the computing device;
determine, based on an aggregated web access history for a plurality of computing devices, a content source associated with the particular geographic region;
receive, from the content source, content designated for use by the predictive knowledge system; and
send, via the communication unit and to the computing device, at least a portion of the content.

14. The computing system of claim 13, wherein the predictive knowledge system is operable by the at least one processor to:
receive, via the communication unit and from the content source, at least one structural definition for the content designated for use by the predictive knowledge system, the at least one structural definition indicating a manner in which the content designated for use by the predictive knowledge system is to be displayed at the computing device; and
send, via the communication unit and to the computing device, the portion of the content for display in accordance with the at least one structural definition,
wherein the at least one structural definition comprises at least one of:
an indication of a font in which a text portion of the content designated for use by the predictive knowledge system is to be displayed by the computing device;
an indication of a font style in which the text portion of the content designated for use by the predictive knowledge system is to be displayed by the computing device; or
an indication of how a background image of the content designated for use by the predictive knowledge system is to be displayed by the computing device.

15. The computing system of claim 13, further comprising:
a computer-readable storage medium configured to cache a version of the content,
wherein the predictive knowledge system is operable by the at least one processor to:
determine a level of recentness for the content based on at least one of: a time at which the version of the content was stored, a current time, the version of the content, or the content; and
send, via the communication unit, at least a portion of the content in response to determining that the level of recentness satisfies a threshold.

16. The computing system of claim 13,
wherein the aggregated web access history comprises respective indications of one or more content sources previously accessed by the plurality of computing devices and respective geographic locations from which the one or more content sources were accessed, and
wherein the predictive knowledge system is operable by the at least one processor to determine, based at least in part on the aggregated web access history, the plurality of defined geographic regions.

17. The computing system of claim 13, wherein the predictive knowledge system is operable by the at least one processor to:
determine, for the particular geographic region, a plurality of content sources associated with the particular geographic region, wherein a respective popularity measure is associated with each content source from the plurality of content sources; and
determine, based at least in part on the respective popularity measures, the content source associated with the particular geographic region.

18. The computing system of claim 17, wherein the predictive knowledge system is operable by the at least one processor to:
receive, via the communication unit and from the computing device, an indication of at least one of: a selection of a user-interface element that includes the content, or a dismissal of the user-interface element; and
responsive to receiving the indication, modify, based on the indication, the respective popularity measure associated with the content source associated with the particular geographic region.

19. The computing system of claim 13, wherein the predictive knowledge system is operable by the at least one processor to:
receive, via the communication unit, a plurality of content portions and indications of corresponding geographic locations for which each of the plurality of content portions are designated for use;
determine, based at least in part on the particular geographic region and the corresponding geographic locations for which each of the plurality of content portions are designated for use and, a particular content portion from the plurality of content portions; and
send, via the communication unit and to the computing device, the particular content portion.

20. A computer-readable storage medium encoded with instructions that, when executed, cause one or more processors of a computing system to:
receive an indication of a current location of a computing device;
determine, based at least in part on the current location of the computing device, a particular geographic region from a plurality of defined geographic regions, the particular geographic region including the current location of the computing device;
determine, based on an aggregated web access history for a plurality of computing devices, a content source associated with the particular geographic region;
receive, from the content source, content designated for use by a predictive knowledge system; and
send, to the computing device, at least a portion of the content.
